(19) United States
(12) Patent Application Publication
(10) Pub. No.: US 2003/0167176 A1
(43) Pub. Date: Sep. 4, 2003

(54) System and method for greeting a visitor

(76) Inventors: Natalie A. Knudson, Madison, WI (US); Austin Y. Park, Oregon, WI (US)

Correspondence Address: BOARDMAN, SUHR, CURRY & FIELD LLP, ATTN: IP PRACTICE GROUP, 1 SOUTH PINCKNEY STREET, FOURTH FLOOR, P.O. BOX 927, MADISON, WI, 53701-0927, US

(21) Appl. No.: 09/815,155

(22) Filed: Mar. 22, 2001

(51) Int. Cl. G06F 17/60

(52) U.S. Cl. 705/1

(57) ABSTRACT

A system and method of welcoming visitors to a business is disclosed. The system includes at least one video conferencing station located in a lobby of the business and at least one receptionist video conferencing station remotely located from the lobby of the business. A receptionist located at the receptionist video conferencing station welcomes the visitor to the business via a video conferencing session.

### REFERENCE TO A COMPUTER PROGRAM LISTING APPENDIX

A computer program listing which comprises Appendix A hereto has been submitted on a single compact disc, in duplicate, in accordance with 37 C.F.R. §§1.52(e) and 1.96(c). The computer program listing appendix is contained in file VGS.TXT which was created on Mar. 22, 2001 and which is 29,088 bytes in length.

The computer program listing contained on the compact disc as file VGS.TXT is hereby incorporated-by-reference herein.

### FIELD OF THE INVENTION

The present invention relates generally to systems and methods for welcoming a visitor to a business. More specifically, it relates to the utilization of video conferencing methods and systems to welcome a visitor to the business.

### BACKGROUND OF THE INVENTION

Many businesses employ one or more dedicated receptionists to welcome visitors to the business. The receptionist typically sits at a front desk located in the lobby or reception area of the business. The terms lobby, reception area and entrance are used interchangeably throughout this disclosure.

When a visitor arrives at the business, the receptionist typically welcomes the visitor and inquires as to the purpose for their visit. If the visitor has an appointment to meet with an employee of the business, the receptionist notifies the employee that the visitor has arrived and is waiting in the lobby. Alternatively, the visitor may simply be making a delivery to, or pick-up from, the business, or may only be seeking information about the business. In any event, a person is typically needed to provide assistance to the visitor in these situations. The dedicated receptionist is that person.

The reception area of any business is typically the first, and perhaps the only, area seen by visitors to the business. As a result, most businesses take steps to insure that the reception area conveys a favorable impression to visitors. To achieve this, the business may tastefully decorate the reception area and require that the reception area remain uncluttered. The business may also require that the reception area be staffed full-time with a dedicated receptionist during normal business hours.

Businesses also typically make information of various kinds available to their visitors in their lobbies. For example, a business may make information about the business itself available to visitors. Or the business may make information available that relates to the business' field or industry. For example, medical information of interest to visitors may be provided in the lobby of a hospital or doctors office or investment information may be provided in the lobby of a brokerage firm. This information is typically provided in the form of brochures, pamphlets or other written materials. These materials are typically placed in a rack located in the reception area.

Many businesses also typically provide some form of entertainment to occupy visitors while they are waiting in the lobby of the business. Typically, this entertainment consists of magazines, newspapers or television.

Businesses that receive a large and continuous stream of visitors throughout the day typically have a need for a full-time dedicated receptionist in their reception area. For many businesses, however, welcoming visitors is not in and of itself a full-time job. Many of these businesses may only staff their lobbies during certain peak times of the day. Or, they may not employ a receptionist at all. There is also the issue of after hours such as evenings and weekends. Many businesses continue to receive visitors during these hours. The volume of visitors received during these hours typically does not justify retaining a full-time dedicated receptionist to staff the lobby. In each of these cases, an alternative to employing a full-time receptionist is desirable.

In each of these cases, however, visitors must still be received and welcomed. To handle this, many businesses simply place a bell or telephone in the lobby when no receptionist is provided. The visitor is instructed to either ring the bell or call someone using the telephone. These two alternatives generally do not convey a favorable impression of the business to the visitor. In each of these cases, an alternative is also desirable.

Staffing a reception area with a dedicated receptionist in these situations is also akin to employing an unproductive employee. For businesses that don't receive a high volume of visitors, it would be desirable to have a multi-tasking receptionist. Multi-tasking, as used herein, means performing both receptionist related tasks (e.g. greeting visitors and answering the telephone) as well as other tasks unrelated to being a receptionist such as secretarial tasks, engineering drafting tasks, bookkeeping and accounting tasks, conducting research or any of a variety of other non-receptionist related tasks.

Unfortunately, for various inherent reasons, the dedicated receptionist may not be able to multi-task. For example, a business typically only staffs its lobby with a single receptionist at any given time and that receptionist is in essence “on call” at all times. This makes it difficult for the receptionist to efficiently and effectively multi-task because of the inability to remain focused on any non-receptionist tasks at hand. It is desirable therefore to have a system and method of greeting a visitor that utilizes a plurality of “on call” receptionists for any one lobby thus avoiding the inherent problems associated with utilizing a single receptionist.

Another reason why a dedicated receptionist may not be able to multi-task relates to the receptionist's surroundings. Unfortunately, the requirement to keep the lobby or reception area tidy and uncluttered previously discussed is not necessarily conducive to productivity. It is desirable, therefore, to provide an environment for the receptionist that is more conducive to productivity and multi-tasking.

Another problem involves staffing the lobby when the dedicated receptionist is away, such as during breaks or during the lunch hour. Typically, a replacement must be utilized during these periods to insure that the lobby is monitored at all times during normal business hours. Businesses will typically leave the lobby unattended during breaks or will use other non-receptionist employees to cover breaks. This leads to more lost productivity as the covering employee is pulled from his or her regular non-receptionist tasks to serve as a receptionist. It is desirable, therefore, to provide a visitor greeting system that allows for complete coverage of the reception area or lobby throughout the entire day. It is also desirable to provide a visitor greeting system that allows for the reception area or lobby to be covered during the dedicated receptionist's absence.

Most small businesses have only one reception area located near a single entrance to the business. For these businesses, employing a single receptionist to cover the lobby is all that is necessary. Many medium sized and large sized businesses, however, have multiple reception areas. For example, a business may be located on several floors of a building with each floor having its own department and its own reception area. Or a business may have multiple entrances, each one staffed with a receptionist to greet visitors. This is especially true for businesses located in large buildings that are spread-out over large areas.

Having multiple buildings located at a single business campus location is also common for large businesses. In these situations, each of the buildings on the business campus typically has its own reception area or areas covered by separate receptionists. Other businesses may have multiple locations throughout town or nation-wide, again each requiring one or more receptionists, depending on the layout and configuration of each of the businesses at each of the locations.

For these medium sized and large sized businesses, it is easy to see that an entire staff of full-time and part-time dedicated receptionists are typically required to monitor the numerous reception areas that are provided to receive visitors to the business. Staffing a single reception area with a full-time dedicated receptionist, let alone numerous reception areas, can be expensive for a business, especially if the receptionists are unproductive due to the factors discussed above. The problem is magnified if an entire staff of receptionists is required to monitor multiple reception areas. It is desirable therefore to have a visitor greeting system that reduces the overall labor cost of staffing a lobby or lobbies to a business.

To reduce labor costs associated with employing a large number of receptionists, a business may designate only one of numerous entrances to their building as the visitor entrance. The remaining entrances are typically used only by authorized individuals such as employees of the business. Employees tend to use the non-visitor entrance that is closest to their office, cubicle or other place of employment within the building. Alternatively, if the business is located on several floors of a building, the business may designate only one of those floors as having the reception area for the entire business.

Having a single visitor entrance can create many problems however. For example, with only one visitor entrance for a large building that is spread-out over a large area, providing adequate close-in visitor parking near the visitor entrance may be difficult. Also, with only one visitor entrance for large buildings, visitor waiting times are increased and the business' employees are likely to be less productive. This is because inevitably some employees will need to come from distant locations in the building to meet with visitors. In many cases, the visitor will be escorted back to the employee's location within the building for a meeting and then will again be escorted back to the visitor reception area at the end of the meeting. All of this travel time back and forth is inefficient and a waste of time that could otherwise be put to productive use. It is therefore desirable to provide a visitor greeting system that allows for a business having multiple entrances and reception areas to receive and greet visitors at each of those entrances and reception areas without having to incur the high labor cost of staffing each entrance with a dedicated receptionist.

For all of the reasons cited above, it is desirable to have an alternative to a dedicated receptionist or staff of receptionists located in the lobby or lobbies of a business. Preferably, this alternative will provide for complete coverage of the reception area or areas of the business during normal business hours and during extended and after hours as well. It is also desirable to have an alternative that allows for increased receptionist productivity and multi-tasking. Preferably, this alternative will also allow the business to monitor all of its entrances and reception areas with increased efficiency and at lower labor costs.

The alternative will desirably also provide both information and entertainment to the visitor. Preferably, the ability to provide such information and entertainment will be modular and can be easily customized to suit the needs of the vast array of businesses that are in existence.

### SUMMARY OF THE PRESENT INVENTION

According to one aspect of the invention, a system for welcoming a visitor to a business includes a lobby video conferencing station and a plurality of receptionist video conferencing stations. Each of the receptionist video conferencing stations is remotely located from the lobby video conferencing station. A receptionist positioned at a randomly selected one of the plurality of receptionist video conferencing stations initiates a video conferencing session with the visitor via the lobby video conferencing station to welcome the visitor to the establishment.

Other principal features and advantages of the invention will become apparent to those skilled in the art upon review of the following drawings, the detailed description and the appended claims.

### BRIEF DESCRIPTION OF THE DRAWINGS

FIG. 1 shows a visitor greeting system according to one embodiment of the present invention;

FIG. 2 shows a lobby video conferencing station according to one embodiment of the present invention;

FIG. 3 shows a receptionist video conferencing station according to one embodiment of the present invention;

FIG. 4 shows an operational flow chart of the visitor greeting system according to one embodiment of the present invention;

FIG. 5 shows a static visual welcoming image used in the visitor greeting system embodiment of FIGS. 4 and 12;

FIG. 6 shows a lobby module splash form used in the visitor greeting system embodiment of FIGS. 4 and 12;

FIG. 7 shows a lobby module main form used in the visitor greeting system embodiment of FIGS. 4 and 12;

FIG. 8 shows a lobby module choice form used in the visitor greeting system embodiment of FIGS. 4 and 12;

FIG. 9 shows a lobby module configuration form used in the visitor greeting system embodiment of FIGS. 4 and 12;

FIG. 10 shows a receptionist module main form used in the visitor greeting system embodiment of FIGS. 4 and 12;

FIG. 11 shows a receptionist module last form used in the visitor greeting system embodiment of FIGS. 4 and 12;

FIG. 12 shows a more detailed operational flow chart of the visitor greeting system embodiment of FIG. 4;

FIG. 13 shows the Flash source code used with the visitor greeting system embodiment of FIG. 4;

FIGS. 14a-c show various embodiments of the present invention used in single building, single lobby applications;

FIGS. 15a-b show various embodiments of the present invention used in business campus applications;

FIGS. 16a-b show various embodiments of the present invention used in business having locations throughout the world;

FIG. 17 shows an embodiment of the present invention used in a visitor greeting answering service application;

FIG. 18 shows the html source code for the web page used with the visitor greeting system embodiment of FIGS. 4 and 12;

FIG. 19 shows a system diagram of the visitor greeting system embodiment of FIGS. 4 and 12 having a single receptionist video conferencing station; and

FIG. 20 shows a system diagram of the visitor greeting system embodiment of FIGS. 4 and 12 having a plurality of receptionist video conferencing stations.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular system configuration having particular features for welcoming visitors to a business, the present invention is not limited to this particular configuration or its features and other configurations having other features can be used. Similarly, while the present invention will be illustrated with reference to a particular method for welcoming visitors to a business, other methods are anticipated and can be used.

Generally, the present invention involves welcoming visitors to a business using video conferencing systems and methods. The term business as used herein is not limited to for-profit organizations but rather includes any type of organization including government and municipal organizations, universities and schools, religious organizations and churches, hospitals and clinics, non-profit and charitable organizations, and any other type of organization that may have the need to greet a visitor.

According to one embodiment of the present invention, a lobby video conferencing station is installed in the lobby or reception area of the business. One or more receptionist video conferencing stations are set-up remote from the lobby. A real time audio/visual video conferencing session is established between the visitor located at the lobby video conferencing station and a receptionist located at one of the receptionist video conferencing stations.

The visitor's presence in the lobby is detected by a visitor sensing device in one embodiment. In another embodiment, no visitor sensing device is provided. An audible signal sounds when the visitor enters the lobby and the visitor is greeted by both a visual greeting image (or movie or animation) displayed on a lobby video output device and by an audio greeting played over a lobby audio output device in this embodiment.

The visitor is instructed to approach the lobby video conferencing station in one embodiment. From the lobby video conferencing station, the visitor requests a video conferencing session with one of the remotely located receptionists by activating a visitor input device.

A selective one of the receptionists located at one of the receptionist video conferencing stations initiates the video conferencing session with the visitor. In an alternative embodiment, only one receptionist video conferencing station is provided and the receptionist at that receptionist video conferencing station initiates the video conferencing session with the visitor.

From the remote location, the receptionist welcomes the visitor to the business and ascertains the purpose for the visit. If the visitor has an appointment to meet with a person or persons at the business, the receptionist notifies the person or persons that the visitor has arrived and is waiting in the lobby. If the visitor is making a delivery or a pick-up, the appropriate person or persons at the business are notified of the visitor's presence in the lobby. If the visitor is merely seeking information about the business, the receptionist either provides the requested information or locates someone at the business who can provide the requested information to the visitor. Once the visitor has been helped, the video conferencing session is ended by the receptionist video conferencing session and the visitor greeting system waits for the next visitor to arrive.

In one embodiment of the present invention, the visitor greeting system also delivers an audio/visual presentation to the visitor. It should be noted that as used herein, the term audio/visual presentation includes audio only presentations and visual only presentations. The audio/visual presentation is customized to provide information about the business in one embodiment. In another embodiment, the audio/visual presentation provides information relating to the field of the business such as medical and health information, investment information, etc . . . . In yet another embodiment, the audio/visual presentation provides entertainment for the visitor such as a movie or television broadcast. In another embodiment, the visitor greeting system can be customized to provide custom audio/visual presentations that suit the needs of various businesses.

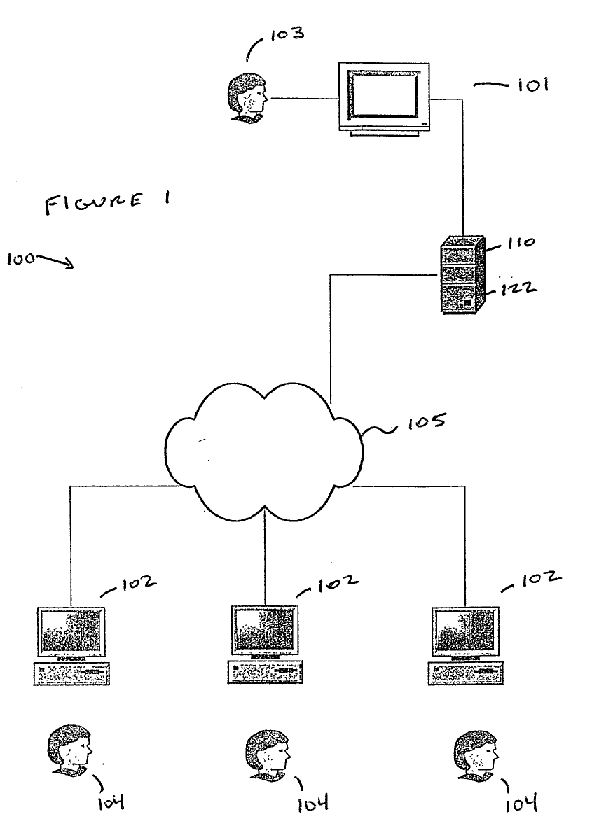

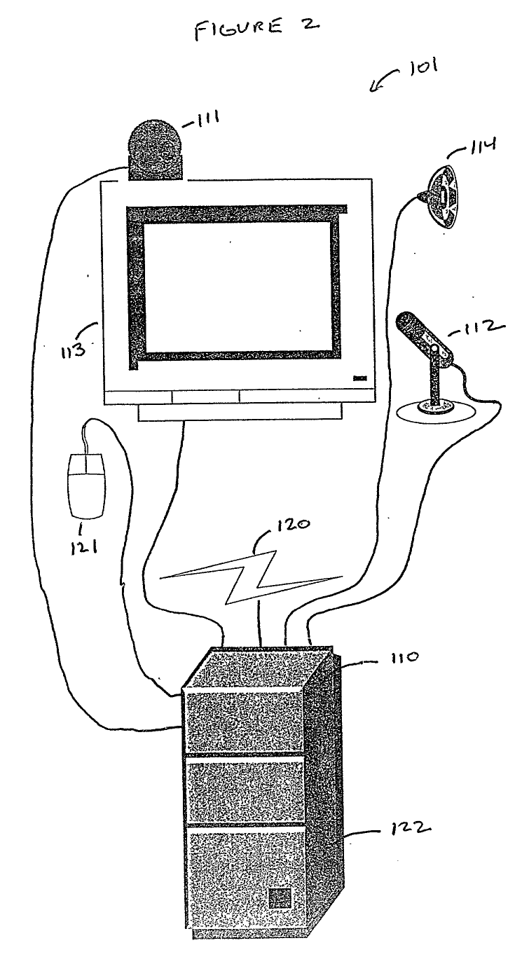

FIG. 1 shows a diagram of a first embodiment of a visitor greeting system in accordance with the present invention. Visitor greeting system 100 includes a lobby video conferencing station 101 and a plurality of receptionist video conferencing stations 102 in this embodiment. Lobby video conferencing station 101 is located in the lobby or other reception area of the business (although some of the components of lobby video conferencing station 101 may actually be located outside of the lobby or reception area as described below). Lobby video conferencing station 101 is typically installed in the lobby at a location readily accessible by a visitor 103 to the business.

Each receptionist video conferencing station 102 is set-up at a location that is remote from the lobby or reception area of the business. The remote locations may be in another part of the same building away from the lobby, or may be in a different building altogether as discussed later herein. Receptionist video conferencing stations 102 are used by remotely located receptionists 104 to greet visitors to the business. In an alternative embodiment, only a single receptionist video conferencing station 102 is connected to lobby video conferencing station 101.

Remotely located when used herein in reference to receptionists and receptionist video conferencing stations means remote from the lobby or reception area. Locally located when used herein in reference to receptionists and receptionist video conferencing stations means in the same building as the lobby or reception area of the business. It should be noted that certain components of the lobby video conferencing station, such as the lobby computer, may be located outside of the lobby or reception area to reduce the amount of clutter in those areas, although this is not a requirement.

Once installed, any one of a plurality of remotely located receptionists 104 using one of the receptionist video conferencing stations 102 can engage in real time visual and audio communication with the visitor 103 located at lobby video conferencing station 101. The remotely located receptionists 104 can welcome the visitor 103 to the business during the video conferencing session and can inquire as to the purpose of the visitor's visit.

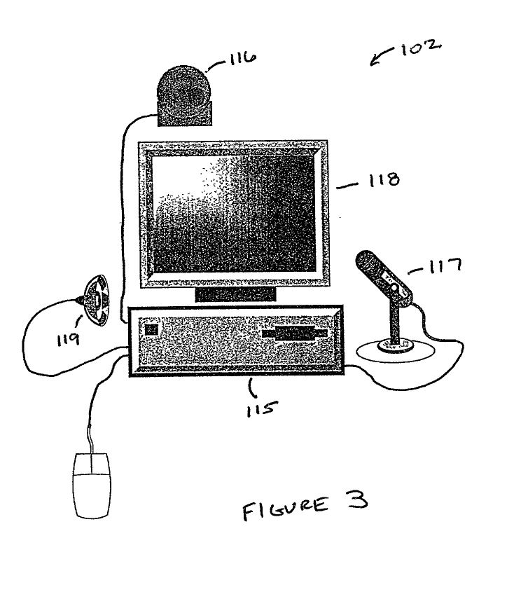

A lobby video conferencing station 101 is shown in FIG. 2 and includes a lobby computer 110, a lobby video input device 111, a lobby audio input device 112, a lobby video output device 113, and a lobby audio output device 114 in the first embodiment of the present invention. Each receptionist video conferencing station 102 similarly includes a receptionist computer 115, a receptionist video input device 116, a receptionist audio input device 117, a receptionist video output device 118, and a receptionist audio output device 119 in this embodiment (see FIG. 3).

It should be noted that it is not necessary to place lobby computer 110 in the lobby or receptions area with the rest of the components that make up lobby video conferencing station 101. In fact, it may be preferable to place lobby computer 110 at a location that is removed from visitor sight to reduce clutter in the lobby. In one embodiment, for instance, lobby computer 110 is placed in a separate room that adjoins the lobby or reception area. In another embodiment, lobby computer 110 is located remote from the lobby. In yet another embodiment, lobby computer 110 is located in the lobby or reception area.

Lobby computer 110 in this embodiment is connected to each of the plurality of receptionist computers 1115 via a local area network (LAN) 105 such as an ethernet or token ring network, although other types of LANs can also be used. LANs are typically (although not always) used when the lobby computer 110 and the receptionist computers 115 are in the same building but this is not required. In other embodiments, a wide area network (WAN), the Internet, a peer-to-peer network or a combination of any of these types of networks are used to connect lobby computer 110 with each of the plurality of receptionist computers 115.

Although any of the above mentioned types of networks can be used to connect lobby computer 110 with the receptionist computers 115, there is no requirement that lobby computer 110 or any of the receptionist computers 115 be authenticated to the network being utilized. For example, neither lobby computer 110 nor any of the receptionist computers 115 are authenticated to the network being used by visitor greeting system 100 in one embodiment of the present invention. In this embodiment, lobby computer 110 and the receptionist computers 115 are simply using the network pathways (e.g. wires, cables, routers, switches, etc . . . ) to communicate with each other. These computers do not have ready access to the networks domain server.

In another embodiment, one or more of the receptionist computers 115 are authenticated to the network while lobby computer 110 is not authenticated to the network being used. In yet another embodiment, all of the computers in visitor greeting system 100 are authenticated to the network being used.

It is actually preferable (but not required) to have one or more of the receptionist computers 115 authenticated to the network. This is because having the receptionist computers 115 authenticated to the network allows the receptionists using the receptionist computers 115 to multi-task more easily. It is also preferable (but not required) to not have lobby computer 110 authenticated to the network being used. This is because the typical location of the lobby computer out in the open raises a greater security threat. By not authenticating the lobby computer 110 to the network being used, it is less likely that someone will be able to gain unauthorized access to the network from lobby computer 110.

Lobby video input device 111 is used to capture an image of visitor 103 during the video conferencing session while receptionist video input device 116 is used to capture an image of the remotely located receptionist 104. Lobby video output device 113 and receptionist video output device 118 are used to visually display the captured images. For example, during a video conferencing session, the image of visitor 103 captured by lobby video input device 111 is visually displayed to the receptionist on receptionist video output device 118. The image of the receptionist captured by receptionist video input device 116 is likewise visually displayed to visitor 103 on lobby video output device 113.

In a similar manner, lobby audio input device 112 is used to capture the visitor's voice signal during the video conferencing session while receptionist audio input device 117 captures the receptionist's voice signal. Lobby audio output device 114 and receptionist audio output device 119 are used to deliver these audio signals. For example, during the video conferencing session, the verbal inquiries and responses of visitor 103 are captured by lobby audio input device 112 and are delivered to the receptionist via receptionist audio output device 119. Likewise, the audio signals of the receptionist are captured by receptionist audio input device 117 and are delivered to visitor 103 using lobby audio output device 114.

In this way, using the various video and audio input and output devices, a receptionist located remote from the lobby at a receptionist video conferencing station can welcome a visitor to the business and inquire as to the purpose for the visit, all through real time audio and visual communication. In an alternative embodiment of the present invention, the communication is not real time.

In the first embodiment, lobby video input device 111 and receptionist video input device 116 are digital cameras such as the 3Com® HomeConnect® PC digital camera model 3718 manufactured by 3Com Corporation, Santa Clara, Calif. Other video input devices are used in other embodiments including digital cameras, analog and digital video cameras, and other analog or digital imaging devices. The term video input device as used herein is not limited to these enumerated devices, but rather includes any device capable of capturing a visual image that can be used or adapted for use during a video conferencing session. The term image as used herein includes still images, static images, animated images and movies.

Lobby audio input device 112 is a separate microphone in the first embodiment. Microphone 112 is placed in the lobby at a location where it can readily capture the voice signal from visitors. Receptionist audio input device 117 is a microphone integrated with a headset (not shown) in this embodiment. In other embodiments, lobby audio input device 112 is an integrated microphone and receptionist audio input device 117 is a separate discrete microphone. Other audio input devices are used in other embodiments including microphones integrated with video output devices and microphones integrated with computers. The term audio input device as used herein includes any device capable of capturing a voice or audio signal or other sounds that can be used or adapted for use during a video conferencing session.

In the first embodiment of the present invention, lobby video output device 113 is a flat panel plasma monitor that can be conveniently mounted on the wall of the reception area or lobby. One such device is the 50″ PlasmaSync® 50PD1 manufactured by NEC Technologies, Inc. of Itasca, Ill. Receptionist video output device 118 is a standard cathode ray tube (CRT) computer video monitor in the first embodiment. In another embodiment, a standard CRT computer video monitor is also used as the lobby video output device. In this embodiment, the CRT monitor is placed in the lobby on a desk or pedestal for use by the visitor. Other types of video output devices are used in other embodiments including liquid crystal display (LCD) monitors, projectors, projection systems, etc. The term video output device as used herein is not limited by the enumerated devices, but rather as used herein includes any device that can be used to visually display or show a visual image during a video conferencing session.

Lobby audio output device 114 is a separate speaker or speaker system in one embodiment of the present invention. One such speaker system is the FourPointSurround™ FPS2000 digital speaker system manufactured by Cambridge SoundWorks, Inc. of Newton Upper Falls, Mass. In other embodiments, audio output device 114 is integrated with lobby computer 110 or lobby video output device 113. Receptionist audio output device 119 is a headset such as the digital or analog headsets manufactured by Plantronics, Inc. of Santa Cruz, Calif. in the first embodiment. In other embodiments, receptionist audio output device 119 is integrated with receptionist computer 115 or with receptionist video output device 118 or is a separate speaker or speaker system. In other embodiments, other audio output devices are used. The term audio output device as used herein is also not limited to these enumerated devices, but rather as used herein includes any device that can be used to deliver voice signals and other sounds during a video conferencing session.

In the first embodiment of the present invention both lobby computer 110 and receptionist computer 115 are personal computers. One such computer is the Compaq® Deskpro® EN Series personal computer manufactured by Compaq Computer Corporation of Houston, Tex. In this embodiment, each computer includes a 733 MHz Pentium® III processor manufactured by Intel Corporation, Santa Clara, Calif., a 10 Gigabyte hard drive, 128 megabytes of RAM system memory and a 48x CD-ROM drive. Lobby computer 110 and receptionist computer 115 are both running the Microsoft® Windows® 2000 Professional operating system in this embodiment.

In addition to the above, each computer in the first embodiment also includes a separate video card for interfacing with the video input and output devices and a separate sound card for interfacing with the audio input and output devices. In other embodiments, no separate video and/or sound cards are used.

Although the present invention is described with reference to a particular computer configuration having certain components, the present invention is not limited to this configuration and other embodiments of the present invention use other configurations and components. For example, other embodiments of the present invention have faster or slower processors, more or less memory or a different operating system is utilized.

The lobby and receptionist computers in this embodiment control the flow of data from and to the various input and output devices in visitor greeting system 100. The non-volatile memory (e.g. hard drive, tape drive, etc . . . ) in each computer is used to store the various computer application programs and data files that may be needed or utilized with visitor greeting system 100 as will be described more fully below. The system memory of each computer stores these application programs while the visitor greeting system is running.

It should be noted at this point that although the first embodiment uses personal computers having built in non-volatile memory and system memory, the present invention is not limited to the use of personal computers and other devices can be used. For example, in another embodiment, dedicated microprocessors are used. In an alternative embodiment, each video conferencing station is networked with a server and the server controls the flow of data from and to the various input and output devices. In other embodiments, one or more computer workstations, mainframes, computer servers or other similar devices are used to control the flow of data between the various input and output devices in the visitor greeting system. In each of the alternative embodiments discussed above, sufficient non-volatile memory and system memory is provided to allow for operation of the visitor greeting system.

It should also be noted at this time that the term video conferencing station means any set-up capable of both capturing the image and voice signal of a person using the station and delivering to that person the image and voice signal of a person located at another video conferencing station. Although the receptionist and lobby video conferencing stations of the first embodiment described above each include their own separate personal computers, there is no requirement that each video conferencing station have its own computer or processor. In the case of a network server acting as the controller, for instance, the video conferencing stations are simply “dumb terminals” in that they merely receive and provide the audio and visual information for the video conferencing session. The server (including its non-volatile memory and system memory) are actually shared by each of the video conferencing stations in this embodiment.

The lobby video conferencing station may include additional components in addition to the components listed above. According to one embodiment of the present invention, for instance, a visitor sensing device 120 and a visitor input device 121 are also included in the lobby setup (see FIG. 2). Video sensing device 120 is used to detect the presence of a visitor in the lobby. Such devices include door sensors, infrared sensors, motion detectors, pressure pads, sound detectors or any other device that can provide a signal to the visitor greeting system indicating that a visitor is present in the lobby or reception area of the business.

Visitor input device 121 in the first embodiment is provided to allow the visitor to request a video conferencing session between lobby video conferencing station 101 and one or a selected one of the receptionist video conferencing stations 102. The visitor input device in this embodiment is a wireless wheel mouse positioned on a pedestal in the lobby. The visitor moves the mouse to position the pointer on the screen of the lobby video output device over a “Call” button to be clicked. Visitor input device as used herein means any device that can provide a signal to the visitor greeting system indicating that the visitor requests a video conferencing session. Such devices include corded and cordless mice and keyboards, infrared mouse devices, touch screens, digital pens, touch pads, etc . . . .

In the first embodiment of the present invention, visitor sensing device 120 initially detects the presence of a visitor to the business and sends a signal to lobby computer 110. Upon receipt of the signal from visitor sensing device 120, visitor greeting system 100 plays various audio and visual greetings welcoming the visitor to the business and instructing the visitor to approach lobby video conferencing station 101. The visitor is further instructed to use visitor input device 121 to request a video conferencing session with a remotely located receptionist as will be described in more detail below.

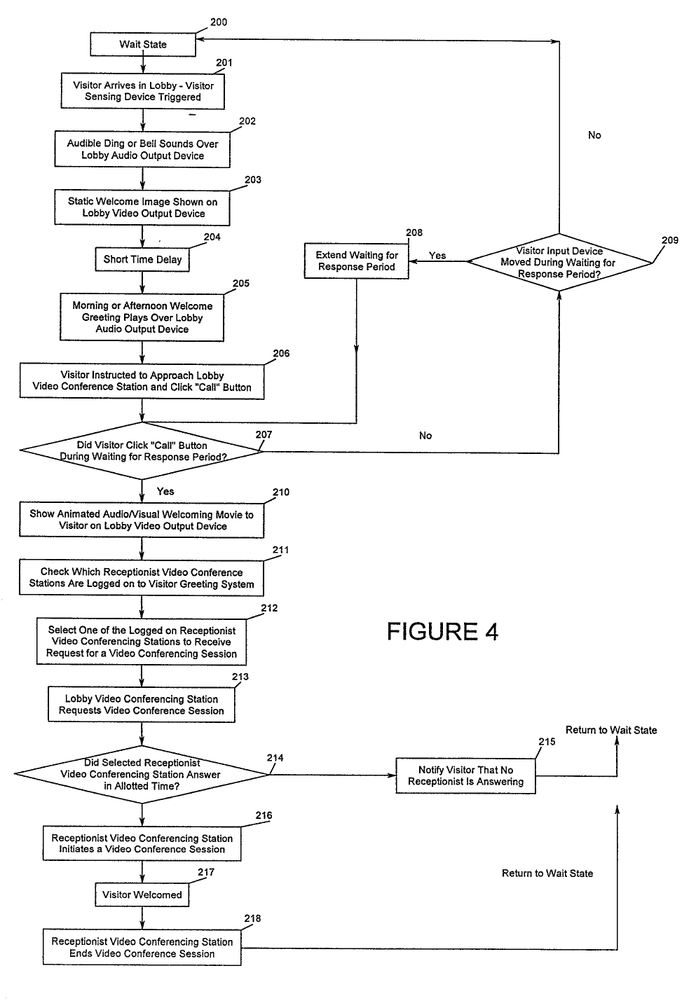

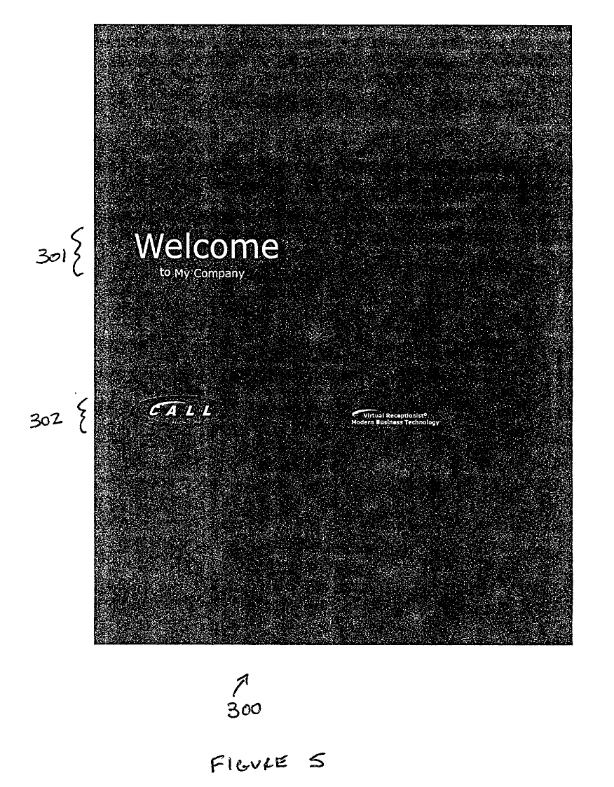

A flow chart showing the general operation of visitor greeting system 100 according to a first embodiment of the present invention is generally shown in FIGS. 4 19-20. The visitor greeting system according to this embodiment is in a waiting state when no visitor is present in the lobby or reception area of the business (see 200).

In one embodiment, a news television program is provided to the lobby via the lobby video and audio output devices during this wait state. To facilitate this, an optional TV player card 122 is connected to lobby computer 110. Commercials or advertisements are provided during the wait state in other embodiments. In two alternative embodiments, a screen saver or nothing is displayed on lobby video output device 113. In yet two other embodiments, music or the radio are played over lobby audio output device 114 during the wait state.

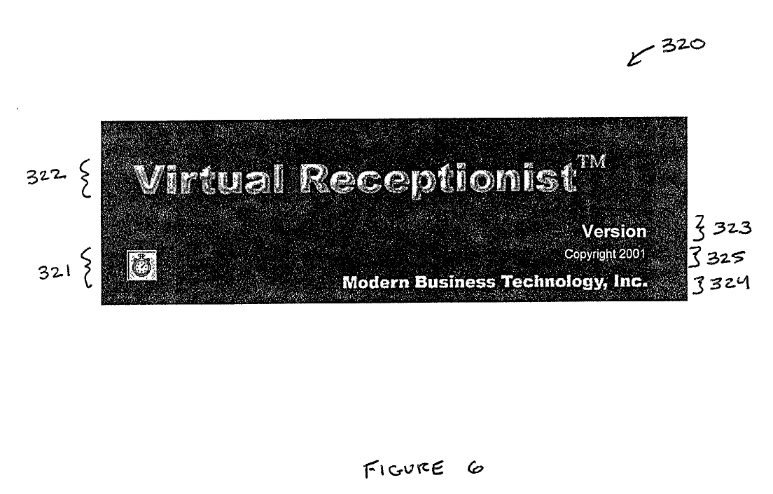

The arrival of a visitor to the lobby or reception area triggers visitor sensing device 120 in the first embodiment (see 201). Visitor sensing device 120 is connected to the lobby video conferencing station. Sensing the arrival of the visitor, the lobby video conferencing station sounds an audible signal (such as a ding or a bell or other similar sound) in this embodiment (see 202). Almost simultaneously with the sounding of the audible signal, the lobby video conferencing station leaves the wait state and displays a static welcome image on the lobby video output device (see 203). An example of one such static welcome display 300 is shown in FIG. 5. In an alternative embodiment, static welcome image 300 is also shown during the wait state.

Static welcome image 300 includes a welcome greeting (e.g. “Welcome to Modern Business Technology”) 301 in this embodiment and includes a “Call” button object 302. In other embodiments, the static welcome image includes other graphic and textual items and may include additional button objects. The present invention is also not limited to the use of static welcome images and fully or partially animated welcoming images or movies or the like can also be used to welcome the visitor at this point in the greeting process. Likewise, in an alternative embodiment, no visual welcoming images or videos are provided to the visitor at this point in the greeting process.

Following a short time delay after the audible signal is sounded (about 5 seconds in this embodiment) (see 204), an audio greeting is played over the lobby audio output device welcoming the visitor to the business (see 205). The audio greeting further instructs the visitor to approach the lobby video conferencing station and use the visitor input device (e.g. a wireless wheel mouse in this embodiment) to click “Call” button 302 shown on the lobby video output device (see 206).

The visitor is given approximately two minutes from the start of the audio greeting to follow the instructions and click the “Call” button in this embodiment (see 207). This time period is referred to as the “waiting for a response” period. In other embodiments, this time period is longer or shorter. Likewise, in other embodiments, the start of the waiting for a response period is triggered by an event other than the start of an audio greeting. For example, the start of the waiting for a response period is triggered by the visitor sensing device or the end of the audio greeting in two other embodiments.

If the “Call” button is not clicked within the waiting for a response time period (see 207), the visitor greeting system returns to the wait state unless the visitor input device was moved during the waiting for a response period (see 208) in which case additional time (e.g. 5 seconds) is added on to the end of the waiting for a response period in this embodiment (see 209). If the mouse is then moved during the extended waiting for a response period without the “Call” button being clicked, another extension is added on to the waiting for a response period (see 209). The waiting for a response period continues to be extended provided the mouse continues to be moved during the preceding extension period without the “Call” button being clicked, otherwise visitor greeting system 100 returns to the wait state.

Activation of the “Call” button at any point prior to the end of the waiting for a response period or any extension of that period results in the visitor greeting system showing an animated audio/visual movie via the lobby video and audio output devices (see 210). At about the same time, the visitor greeting system checks to see which of the plurality of receptionist video conferencing stations 102 are logged on to visitor greeting system 100 (see 211) and randomly selects one of the logged on receptionist video conferencing systems to receive the request for a video conferencing session (see 212). At this point lobby video conferencing station 101 places a call to the selected receptionist video conferencing station 104 requesting a video conferencing session (see 213).

If the request is not answered within a certain predetermined period of time (e.g. 30 seconds in the first embodiment) (see 214), a message is displayed on lobby video output device 113 advising the visitor that the receptionist is not answering the call (see 215). Visitor greeting system 100 then returns to the wait state.

If the receptionist video conferencing station is staffed by a remote receptionist, the remote receptionist answers the call initiating the video conferencing session with the visitor (see 216). The receptionist's image and voice are captured by receptionist video and audio input devices 116, 117 mounted at the receptionist video conferencing station. The visual and audio signals are transmitted to lobby video conferencing station 101 where they are delivered to the visitor for viewing and listening via lobby video and audio output devices 113, 114 respectively. Likewise, the visitor's image and voice are captured by lobby video and audio input devices 111, 112 mounted at lobby video conferencing station 101, are transmitted to the selected receptionist video conferencing station 104 and are delivered for viewing and listening by the remotely located receptionist via receptionist video and audio output devices 118, 119 respectively.

The remotely located receptionist welcomes the visitor to the business and inquires as to the purpose for the visitor's visit (see 217). If the visitor is visiting the business to meet with someone, that individual is notified and the visitor is informed that the person will be with them shortly. If the visitor is there to make a pickup or a delivery, the proper individuals at the business can be notified of the visitor's arrival and presence in the lobby. Similarly, if the visitor is merely seeking information, the remotely located receptionist can take the necessary steps to answer the visitor's questions and send him or her on their way.

Once the video conferencing session is completed, the receptionist video conferencing station ends the video conferencing session (see 218) and the visitor greeting system returns to its wait state ready for a new visitor to arrive at the business.

As outlined above, the first embodiment of the present invention provides a certain sequence and combination of pre-recorded audio, visual and audio/visual greetings to welcome the visitor to the business and instruct the visitor regarding how to proceed. It should be noted at this time that the invention is not limited to this particular sequence or combination of pre-recorded greetings and other audio, visual and audio/visual greetings can be used. In one embodiment, for instance, only pre-recorded audio greetings and instructions are provided. In another embodiment, only visual greetings and instructions are provided, such as signs instructing the visitor how to request a video conference with a receptionist.

Although the first embodiment of the present invention randomly selects one of the plurality of receptionist video conferencing stations to receive the request for a video conferencing session from the lobby video conferencing station, the invention is not limited to this method and other methods can be used. In fact, any method that allows a selective one of the receptionist video conferencing stations to receive the request for a video conferencing session can be used.

For instance, in one embodiment, one or more receptionist video conferencing stations are identified as primary stations while one or more receptionist video conferencing stations are designated as back-up stations. The primary stations are called first and the back-up stations are called only if the primary stations do not answer the call. In another embodiment, the visitor greeting system simply cycles through the list of receptionist video conferencing stations one at a time until each one has received a request and then the process starts all over again at the beginning of the list. In yet another embodiment, automatic call distribution or call hunting are used.

It is also not necessary that only one receptionist video conferencing station receive the request for a video conferencing session from the lobby video conferencing station. In one embodiment, a request is actually made to all of the receptionist video conferencing stations and the first one to answer the call is selected to engage in the video conferencing session with the visitor.

In an alternative embodiment of the present invention, the video conferencing session can be initiated without having the visitor activate a visitor input device. In this embodiment, an audible signal is sounded in the back-end of the building when the visitor is detected by the visitor sensing device. The audible signal is typically sounded in an area where a remote receptionist video conferencing station is located. In another embodiment, a plurality of receptionist video conferencing stations are located in the back-end of the building.

When the receptionist hears the audible signal, he or she initiates the video conferencing session between the remotely located receptionist video conferencing station and the lobby video conferencing station. The visitor can then be welcomed and helped. While the visitor is waiting in the lobby for the video conferencing session to begin, an audio or audio/visual greeting is delivered to the visitor via the lobby video and audio output devices in this embodiment, although this is not required.

The visitor greeting system according to the first embodiment of the present invention includes a visitor greeting computer program. This computer program includes two program modules. The first is a lobby program module that is stored (e.g. on the hard drive), installed and runs on the lobby computer that is part of the lobby video conferencing station. The second program module is a receptionist program module that is stored, installed and runs on each of the receptionist computers that are part of each receptionist video conferencing station in this embodiment. The visitor greeting computer program and each of its modules are stored on a floppy disk or a CD-ROM in other embodiments.

Most of the program objects in the two program modules were developed using the Microsoft® Visual Basic® development system in this embodiment, although there are also objects in the lobby program module that are written in html (e.g. Hyper Text Markup Language) and Macromedia Flash®. Each of the objects contained in these programs will be described in detail below.

Although the visitor greeting computer program is configured in a certain manner in this embodiment using certain objects and combination of objects, it should be understood that the present invention is in no way limited to this particular configuration or to these particular objects or combination of objects. It should also be understood that other program languages can be used in other embodiments of the present invention.

The lobby program module includes a splash form object, a main form object, a choice form object, a main model object and a bubble class object. When the lobby program module is first started, the splash form object, the main form object, the choice form object and the main model object are loaded into the system memory of the lobby computer from the hard drive. The main form, choice form and configuration form are initially hidden and thus are not shown on the lobby video output device while the lobby program is being loaded. The splash form, on the other hand, is shown briefly on the lobby video output display while the program is being loaded. Thereafter, the splash form object is unloaded from system memory and the main form is shown on the lobby video output display.

The main form object, in combination with an html object and a multimedia player object controls the overall operation of the visitor greeting system in the first embodiment of the present invention. The choice form object provides the computer system administrator with the ability to run the lobby program module, enter the re-configure mode of the lobby program module, or quit the lobby program module. The configure form object is provided to allow the computer system administrator the ability to reconfigure the lobby program module or to customize certain aspects of the visitor greeting system in this embodiment.

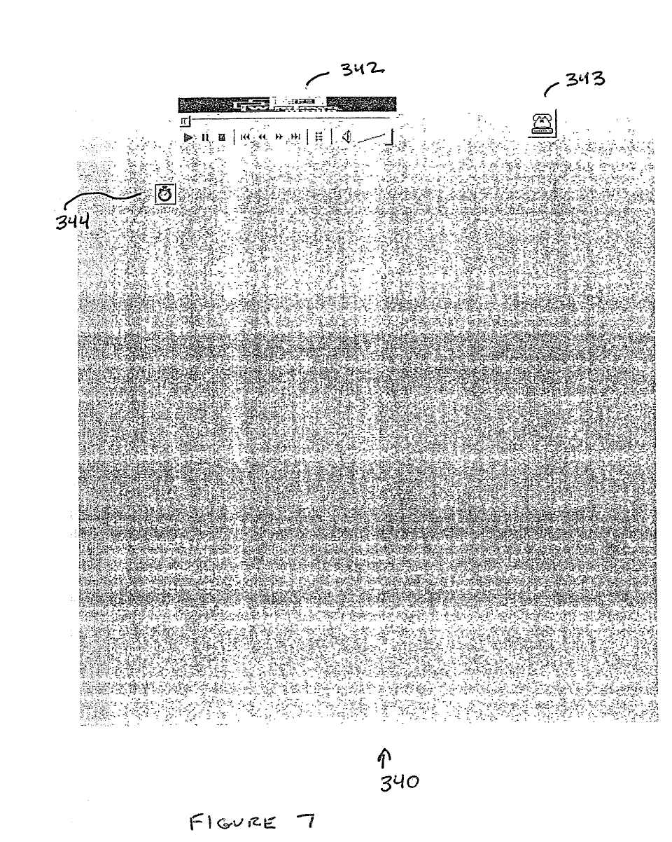

The splash form object (frmSplash) is loaded into system memory when the lobby program module is first loaded. During loading, the run time version of the design time splash form 320 shown in FIG. 6 is displayed on the lobby video output device. Embedded in this form object is a timer object 321 that sets a time limit on how long the splash form is displayed (2 seconds in the first embodiment). After the expiration of this time limit, the splash form object is automatically unloaded from system memory and the main form is shown on the lobby video output device.

The splash form object is also configured to unload itself if any key on a keyboard attached to the lobby computer is pressed or if a pointing device connected to the lobby personal computer is clicked. If either event occurs prior to expiration of the time limit, the splash form object automatically unloads itself from memory and the main form is displayed on the lobby video output device.

The main purpose for displaying the splash form is to identify the name of the program being loaded and the version being loaded. To accomplish this, the splash form object in this embodiment includes an embedded picture object 322 and an embedded text label object 323. Picture object 322 displays the stylized “Virtual Receptionist” product name in this embodiment. Text label object 323 displays the version of the receptionist greeting program being run. In this embodiment, the splash form object automatically tracks, updates and displays the current version of the visitor greeting computer program.

Also embedded in the splash form object in this embodiment is a second picture object 324 that is used to display the business' name (e.g. Modern Business Technology, Inc.) and a second text label object 325 that is used to display a copyright notice for the visitor greeting computer program.

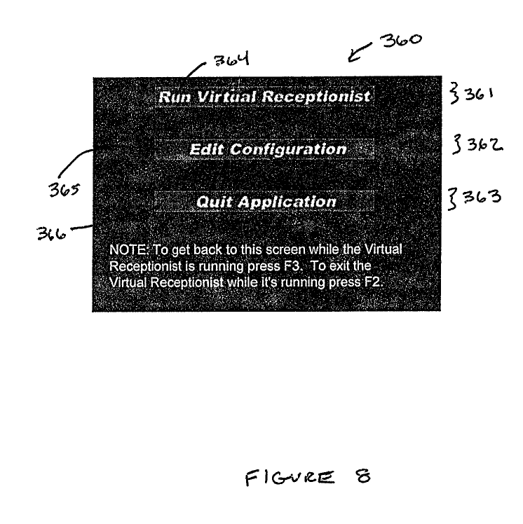

Once the splash form object has been unloaded from system memory, the main form 340 is shown on the lobby video output device (FIG. 7 shows the design time version of the main form). The main form object (frmMain) is configured such that the height and width of main form 340 is equal to the height and width of the screen of the lobby video output device in this embodiment. The height and width of main form 340 are specified in the form code although in other embodiments these values are set during the design time of the main form object. In either case, the height and width of main form 340 can be set to any desired values in alternative embodiments of the present invention.

The main form object includes four embedded objects and numerous form code subroutines and functions, all of which help control the overall functionality of the visitor greeting program. The four embedded objects include an active x web browser object (not shown), an active x media player object 342, a communication object 343 and a timer object 344.

Communication object 343 allows the main form object to monitor the communication port connected to the visitor sensing device. The particular communication port to which the visitor sensing device is connected is obtained by the main form object from the lobby computer's operating system registry at the time the main form object is loaded. The main form object monitors the communication port continuously listening for a signal from the visitor sensing device indicating that a visitor is present in the lobby.

Media player object 342 is used to provide both an audible signal (ding or bell sound) to the visitor when a signal is received from the visitor sensing device and to play a pre-recorded audio greeting to the visitor shortly after the audible signal sounds in this embodiment. The audible signal and pre-recorded audio greeting are delivered to the visitor via the lobby audio output device.

The main form object is configured to play a pre-recorded audio morning greeting during the first half of the day (e.g before 12 noon in this embodiment) and an afternoon audio greeting during the second half of the day (e.g. at or after 12 noon). Other embodiments may only play a single pre-recorded audio greeting, more than two different pre-recorded audio greetings or no pre-recorded audio greetings.

The web browser object serves two purposes in this embodiment of the present invention. First, the web browser object facilitates the delivery of an audio/visual greeting to the visitor. Second, the web browser facilitates the video conferencing session between the visitor and the remotely located receptionist. In this embodiment, the web browser object is the Microsoft® Internet Explorer web browser developed by Microsoft Corporation, Redmond, Calif., although other web browsers can be used.

The web browser object is loaded into system memory by the main form object when the lobby program module is started. The web browser display area is set to be larger than the screen of the lobby video output device in this embodiment. This is done to cover-up or hide the various border elements of the operating system's graphical user interface such as the task bar and system tray. In this embodiment, the height and width of the web browser display are specified in the form code although in other embodiments these values are set at design time. In either case, the height and width of the web browser display can be set to any desired values in alternative embodiments of the present invention. Once loaded, the web browser object is configured to immediately load an html web page.

The main form object also assigns certain functions to two keyboard function keys, namely F2 and F3. Function key F2 is assigned the function of exiting or quitting the lobby program. When this function key is pressed, a standard message box appears on the lobby video output device asking the question “Are you sure you want to quit?” and providing the computer system administrator with two button choices, namely “Yes” or “No”. If the user selects the “Yes” button, the lobby program module quits running and is unloaded from system memory. In addition, all other active application programs (e.g. the web browser) started by the lobby module are also stopped and unloaded from system memory. If the “No” button is selected, the lobby program module continues to run.

Pressing the F3 key automatically hides the main form and shows the choice form on the lobby video display. We will discuss the choice form in more detail below.

Timer object 344 in this embodiment is provided as a tool to monitor movement of the visitor input device attached to the lobby computer. If movement of the visitor input device is detected during the waiting for a response period, it is assumed that a visitor is present in the lobby and is moving the visitor input device. In that situation, it may be desirable to extend the waiting for a response period to allow the visitor additional time to request a video conferencing session. The timer object provides these extensions.

The timer object is normally disabled unless movement of the visitor input device is detected during the waiting for a response period. Movement of the visitor input device during this period enables the timer object. The timer object then starts counting down at the end of the waiting for a response period thereby extending the waiting for a response period by the amount of time set on the timer object (e.g. 5 seconds in the first embodiment). If any movement of the mouse is detected while the timer is enabled, the timer is reset when it runs out of time and the waiting for a response period is again extended by the same amount of time (e.g. 5 seconds). This process continues until either the visitor input device is activated (e.g. clicked) or until no movement of the visitor input device is detected while the timer is running.

The operation and interaction of the main form object with other lobby program modules will be described in detail below. First, however, several other lobby program module objects will be described.

A bubble class object (clsBubble) is included in the lobby program module. Bubble class objects are well understood by those of ordinary skill in the art. Suffice it to say that the bubble class object in this embodiment is used as a communication bridge to bridge the communication of information between the main form object created using the Visual Basic® development system and the web browser running the web page which is programmed using the html language. The bubble class object allows the main form object to view what is taking place inside of the web browser object and inside of the html page. In this embodiment, the bubble class object monitors the html web page and notifies the main form object if any of the embedded buttons on the html web page have been clicked.

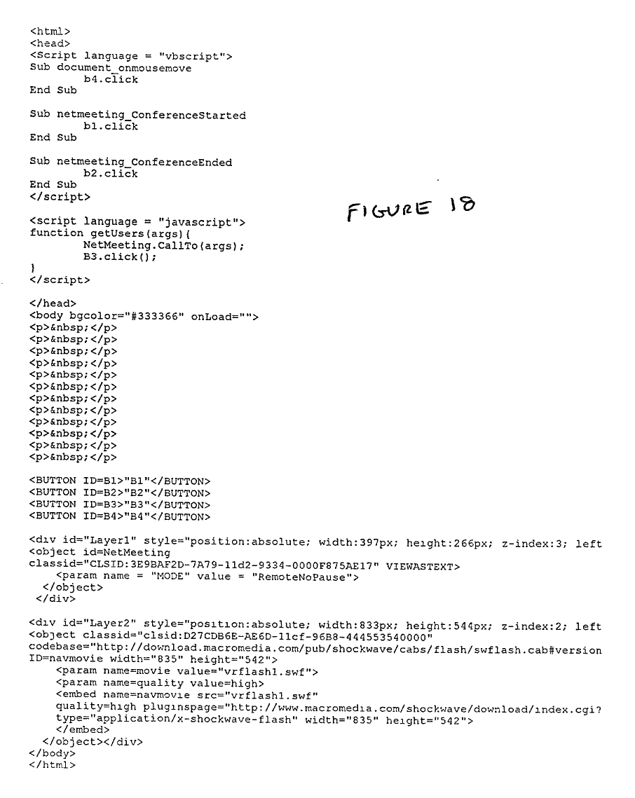

The html web page in this embodiment (see FIG. 18 for html source code) has a second active x multimedia player object and an active x video conferencing object embedded into itself. The second multimedia player object in this embodiment is a Macromedia Flash® multimedia player developed by Macromedia, Inc., San Francisco, Calif. The multimedia player object is used to deliver an animated audio/visual greeting to the visitor via the lobby video and audio output devices.

The video conferencing object is used to conduct the video conferencing session between the visitor and the remotely located receptionist. In this embodiment, the video conferencing object is the NetMeeting® conferencing system developed by Microsoft Corporation, Redmond, Wash. We will discuss the interaction of the html web page with the multimedia player object and the video conferencing object below.

The html web page also has four invisible button objects embedded into itself. These embedded button objects are included for the purpose of providing a signal that can be detected by the bubble class object. The bubble class object can then notify the main form object that a button on the html page has been clicked. This allows the html web page to communicate indirectly with the main form object.

Three of these button objects correspond to stages of the video conferencing session, namely the request (e.g. call) for a video conferencing session, the initiation (e.g call answered) of a video conferencing session and the end of a video conferencing session. At each of these stages, the html page activates (e.g. clicks) the button corresponding to that particular stage. Activation of these buttons is monitored by the bubble class object. The bubble class object notifies the main form object if and when any of these buttons are activated. In this way, the main form object knows when a video conferencing session has been requested, has been initiated or has ended.

The fourth button object provides information regarding movement of the visitor input device (e.g. by monitoring movement of the pointer on the screen of the lobby video output device). When the visitor input device is moved, this button is activated by the html web page. The bubble class immediately notifies the main form object that this button has been activated. In this manner, information concerning the movement of the visitor input device is provided to the main form object.

The multimedia player object embedded into the html web page serves two purposes in this embodiment. First, it is used to provide an animated audio/visual greeting via the lobby video and audio output devices. Second, it selectively identifies which of the plurality of receptionist video conferencing stations are to receive a request for a video conferencing session from the lobby video conferencing station.

The animated welcoming audio/visual greeting includes two scenes in this embodiment. The first scene is a static welcome display 300 (see FIG. 5). This scene is shown on the lobby video output device immediately after a visitor enters the lobby. There is no audio signal associated directly with static welcoming display 300 in this embodiment although in other embodiments an audio signal is also provided. In another embodiment, the static welcome display scene is also shown on the lobby video output device during the wait state when no visitor is present in the lobby.

Static welcome display scene 300 includes a “Call” button object 302. Activation of “Call” button object 302 by the visitor starts scene two of the animated welcoming audio/visual and starts the process for requesting a video conferencing session as will be described in more detail below. The second scene is an animated movie in this embodiment that includes audio/visual information about the business and audio information regarding the status of the video conferencing session.

The process for initiating a video conference begins with the multimedia player object in this embodiment. Upon activation of “Call” button object 302, the multimedia player object retrieves the e-mail addresses of the receptionist computers that are logged on to the visitor greeting system and randomly selects one of them to be called in order to establish a video conferencing session between the selected receptionist video conferencing station and the lobby video conferencing station. Once the address of the selected receptionist computer is identified by the multimedia player object, it is passed to the html web page object for use in initiating the video conferencing session as will be described below in more detail.

A main model object (mdlMain) is also included in the lobby program module. Main model objects of the sort used in this embodiment are well understood by those of ordinary skill in the art. The main model object used in this embodiment performs two functions. First, the main model object checks the lobby computer during loading to determine if there are any other instances of the lobby program module loaded and running on the lobby computer. If another instance of the lobby program module is discovered, the main model object displays a message indicating that the lobby program module is already running. At this point, the main model object quits and unloads all of the objects that were being loaded as part of the second instance of the lobby module. In addition, any other active applications that were loaded or being loaded as a result of the loading of the second instance of the lobby program module are also closed and unloaded.

The second function performed by the main model object in this embodiment is that it tracks the location of the pointer associated with the visitor input device on the screen of the lobby video output device. This location information is used by other objects as will be described below.

A choice form object (frmChoice) is included in the lobby program module. Like some of the other objects described above, choice form objects of the sort used in this embodiment are well understood by those of ordinary skill in the art. The choice form object is provided in this embodiment to allow the computer system administrator to reconfigure or customize the receptionist greeting program or to quit or exit the lobby program module.

The choice form object is loaded into system memory when the lobby program module is started. The choice form is hidden at that time and therefore not shown on the lobby video output device. To show the choice form, the F2 function key is pressed on the keyboard connected to the lobby computer in this embodiment.

When the choice form is first shown, the choice form object checks the lobby computer's operating system registry to make sure that all of the appropriate program settings for the lobby program module are present. It does so by checking only one of these settings in this embodiment, namely the COMport setting. If the COMport setting is empty, the choice form object assumes all of the settings are empty and the choice form object saves all of the default settings into the operating system registry.

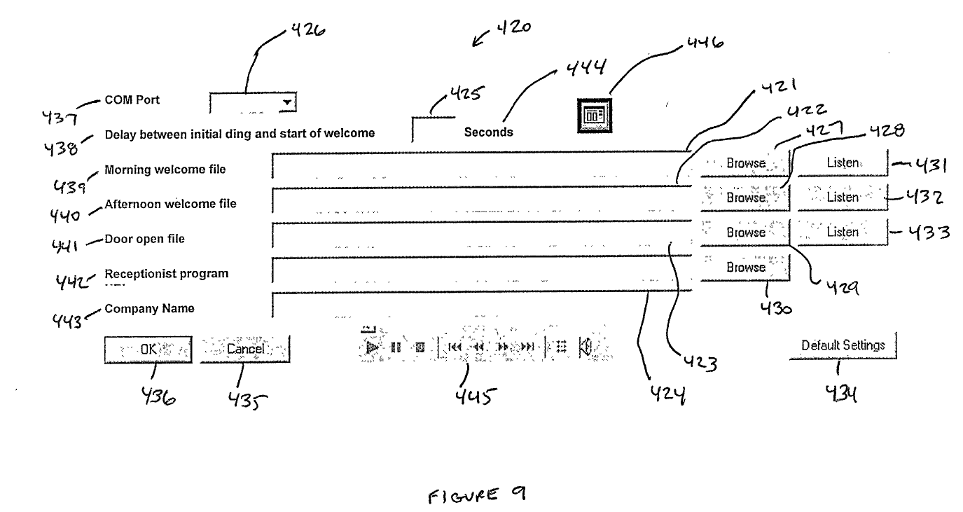

The choice form 360 as shown in FIG. 8 (design time version) includes three image button objects 361, 362 and 363. Clicking the first of these button objects 361 shows the main form and allows the lobby program module to continue running. Clicking the second of these button objects 362 shows the configuration form allowing the computer system administrator to reconfigure or customize the visitor greeting system. Clicking the third of these image button objects 363 shuts the lobby program module down, along with all active applications opened by the lobby program module.

Overlaid on each of the image button objects are two picture objects. The first set of picture objects 364, 365, 366 overlaying the image button objects provide the names for each button (e.g. “Run Virtual Receptionist” or “Edit Configuration” in this embodiment). The second set of overlaid picture objects (not shown) show the same button names in highlighted form. The choice main form object is configured such that when a pointing device moves over a button object, the overlaid picture object switches from the first picture image to the second picture image giving the illusion to the observer that the image button is being highlighted as the pointing device is moved over the button object.

A configuration form object (frmCfg) is also included in the lobby program module. Configuration form objects like the one used in this embodiment are well understood by those of ordinary skill in the art. The configuration form object included with the lobby program module is provided to allow a business to reconfigure or customize the visitor greeting system to suit their own particular business needs.

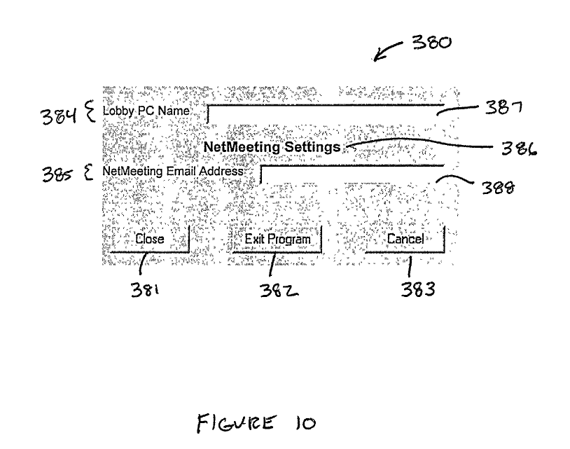

Configure form 420 is shown in FIG. 9 (design time version) and includes five text box objects 421-425, a combo box object 426, ten image button objects 427-436, eight label objects 437-444, an active x media object 445 and a common dialog box object 446.

Text box object 421 is provided to identify the file name and location of the file that contains the pre-recorded audio morning greeting while text box object 422 is provided to identify the file name and location of the file that contains the pre-recorded audio afternoon greeting in this embodiment. Text box 423 is provided to identify the file name and file location of the file containing the pre-recorded audio ding or bell sound. These files are typically stored on the hard drive of the lobby computer although this is not a requirement. Label objects 439, 440 and 441 are provided to identify these three text boxes.

Generally, the visitor greeting system is provided with generic pre-recorded audio default files that can be used by any business. If a business desires to customize any of these files, it can easily do so by creating its own pre-recorded audio files. The visitor greeting system according to the first embodiment of the present invention uses a standard audio file format (e.g. .wav files) for its audio files making customization easy. However, the present invention is not limited to this file format and other file formats can also be used.

To customize the visitor greeting system in this embodiment, the business simply enters the file name and file location of the custom audio file in the appropriate text box on the configure form. Standard Browse button objects 427-429 and common dialog box object 446 are provided to easily facilitate editing these text boxes. Listen button objects 431-433 and active x media player 445 provide the party editing the visitor greeting system with the ability to preview (e.g listen to) any of the pre-recorded audio files identified in the text boxes.

Combo box object 426 is provided to identify and/or change the particular lobby computer Communication port to which the visitor sensing device is attached. This object provides a drop down menu of choices when the arrow next to the box is clicked. Label object 437 is provided to identify this box.

Text box 425 indicates how long the delay will be between the audible ding and the start of the audio greeting. This delay can be changed by entering a new value into text box 425. Label objects 438 and 444 are provided to identify this text box.

Clicking default button object 434 resets all of the settings to their default values. Clicking cancel button object 435 leaves all of the settings as they were before configure form 420 was shown without any changes being made. Clicking OK button image 436 changes all of the settings to those that appear on configure form 420 when the OK button object 436 is clicked. Clicking cancel button object 435 or OK button object 436 also hides the configure form and shows the main form on the lobby video output device.

We now turn our attention to the receptionist program module. The receptionist program module includes three form objects in the first embodiment, namely a splash form object, a main form object and a last form object. The program module also includes a module of system tray code. The receptionist program module is stored on the hard drive of each of the receptionist computers in this embodiment. The receptionist module is typically started when a receptionist computer is first booted-up. At that time, all three form objects and the system tray code module are loaded into system memory. An icon for the receptionist module is placed in the operating system's system tray and is displayed on the receptionist video output device.

The splash form object (frmSplash) in the receptionist program module is identical to the splash form object in the lobby program module and operates in the same manner. The form object is initially loaded into system memory when the receptionist program module is loaded. Splash form 320 (see FIG. 6) is briefly displayed on the receptionist video output device upon loading. Thereafter, the splash form object is unloaded from system memory. Unlike with the lobby module, however, the main form is not shown on the receptionist video output device when the splash form object is unloaded. Instead, an icon for the receptionist program module is shown on the receptionist video output device appearing in the operating system's system tray.

The receptionist module's main form object (frmMain) serves two main functions. First, it allows the receptionist using the receptionist computer to login and logoff from the receptionist greeting system. Second, it notifies the lobby computer regarding the receptionist computer's status as logged in or logged off. Before we discuss how this is accomplished, however, we should briefly discuss the main form.

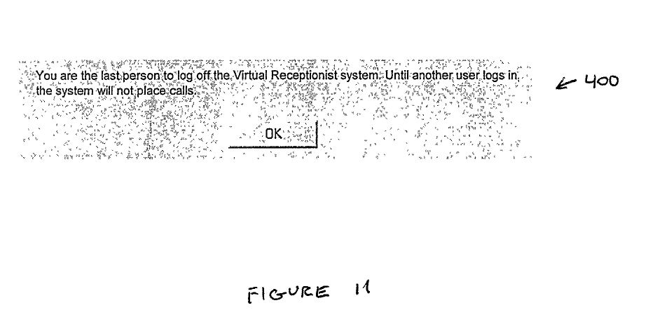

The main form object includes a main form 380 shown in FIG. 10 having three button objects 381, 382, 383 (labeled “Close”, Exit Program” and “Cancel”), three text label objects 384, 385, 386 and a pair of text boxes 387, 388. Label objects 384 and 385 are provided to identify the contents of text boxes 387, 388 (e.g. “Lobby PC Name” and “NetMeeting Email Address”) while the third label object 386 provides a title for main form 380 (e.g. “NetMeeting Settings”).

The “Lobby PC Name” text box 387 contains the lobby computer's operating system name. Providing this name to the receptionist computer allows the receptionist computer to identify and communicate with the lobby computer. The “NetMeeting Email Address” text box 388 contains an address for the receptionist computer. This address is used by the NetMeeting® video conferencing object in this embodiment to identify the receptionist computer when a request is made by the lobby computer for a video conferencing session. It should be noted that the text in these boxes can only be edited when the receptionist computer is logged off from the visitor greeting system. When the receptionist computer is logged on, the ability to edit the contents of the text boxes is disabled.

Clicking on “Close” button 381 saves the lobby PC name and NetMeeting e-mail address appearing in text boxes 387, 388 to the operating system registry of the receptionist computer and minimizes main form 380 (e.g. returns it to an icon in the operating system's system tray). Clicking on the “Cancel” button 382 allows the user to minimize main form 380 without making any changes to the receptionist computer's operating system registry. We will discuss the “Exit Program” button 383 below.

To show the main form on the receptionist video output device, the receptionist clicks on the visitor greeting system icon in the system tray and then clicks on the word “Configure” from the pop-up menu that appears.

When the main form object first loads into system memory, the computer name of the lobby computer and the NetMeeting e-mail address are retrieved from the receptionist computer's operating system registry and assigned to text boxes 387, 388 of main form 380. These two items were first placed in the operating system registry of the receptionist computer when the receptionist program module was loaded for the first time on the receptionist computer.

Knowing the name of the lobby computer, the receptionist computer next retrieves a text data file from the hard drive of the lobby computer using a Microsoft® network shared name. The text data file is stored on the hard drive in a share directory that is accessible by all of the receptionist computers. In the event that the text data file does not exist, the main form object will indicate that an error has occurred.

The text data file contains the NetMeeting e-mail addresses for all of the receptionist computers that are logged on to the receptionist greeting system at any given time. Every time a receptionist computer logs on or logs off, this list is updated. The updating is accomplished in the following manner.

The process for adding the NetMeeting address to the text data file during the logging in process is as follows. The receptionist program module first retrieves the lobby computer name and its own NetMeeting e-mail address from its own operating system registry. It then reads the text data into its own system memory from the text data file located in the share directory on the hard drive of the lobby computer.

The main form module then checks to see if its own NetMeeting e-mail address is already listed in the text data. If it is, nothing further is done. If it is not, it is added to the text data and the updated text data is rewritten to the text data file on the hard drive of the lobby computer. At this point, the receptionist computer is logged into the visitor greeting system and can engage in video conferencing sessions with the lobby video conferencing station.

The process for deleting the NetMeeting address from the text data file during the logging off process is similar. The receptionist program module first retrieves the lobby computer name and its own NetMeeting e-mail address from its own operating system registry. It then reads the text data into its own system memory from the text data file located in the share directory on the hard drive of the lobby computer.

The main form module then checks to see if the receptionist computer is the last receptionist computer logged in to the receptionist greeting system. If it is the last computer logged in, the last form 400 (see FIG. 11)is shown on the receptionist video output device notifying the receptionist that he or she is the last person to log off of the receptionist greeting system. The main form module then removes its own NetMeeting e-mail address from the list and writes the updated list to the text data file on the hard drive of the lobby computer.

The process outlined above for updating the text data file occurs when a receptionist logs on or logs off from a receptionist computer. To do this, the receptionist simply clicks on the visitor greeting system icon displayed on the receptionist video output device in the system tray. Once clicked, a pop-up menu offers the receptionist the option to log on or log off depending on the current state. Choosing either of these options will automatically result in the text data file being updated as described above.

In addition to formally logging in and logging out per se, the icon's pop-up menu also provides the receptionist with an “Away from Desk” check box option. Rather than log off, the receptionist can simply check the “Away from Desk” check box on the pop-up menu. From a system point of view, checking the “Away from Desk” check box is the same as logging off in that the text data file is updated to remove the receptionist computer's NetMeeting email address from the list of logged on receptionist computers. When the receptionist returns and un-checks this box on the icon's pop-up-menu, the text data file is again updated to add the receptionist computer's NetMeeting e-mail address back into the text data file.

Clicking on the “Exit Program” button on the main form also updates the text data file as described above and quits the receptionist program module. Quitting the receptionist program module unloads the program from the system memory of the receptionist computer and removes its icon from the operating system's system tray. Finally, the main form object is also configured to update the text data file as described above if the receptionist program module iis inadvertently unloaded or shut down (e.g power outage or computer glitch).

The receptionist program module also includes a module of system tray code. This type of module is well understood by those of ordinary skill in the programming art and will not be described in detail. Suffice it to say that in this embodiment of the present invention, the module of system tray code defines the system types of variables and constants for the receptionist computer's operating system's system tray.

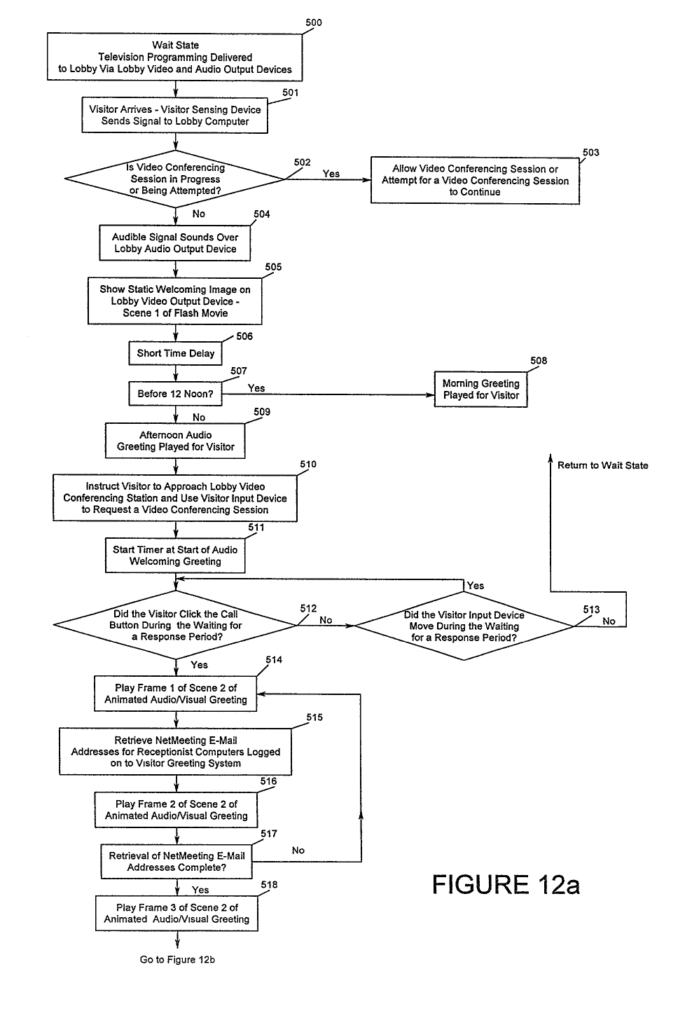

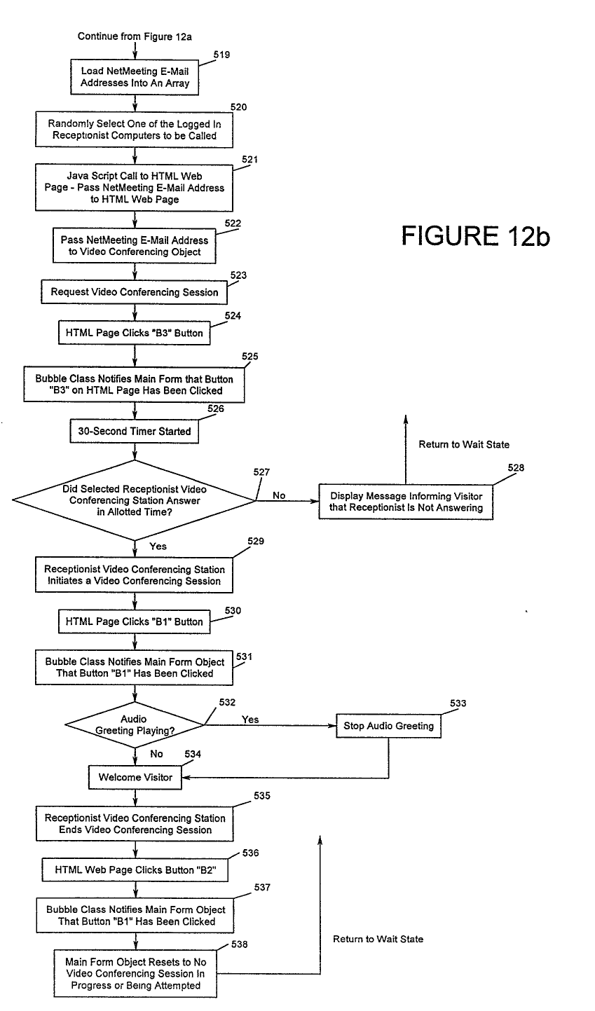

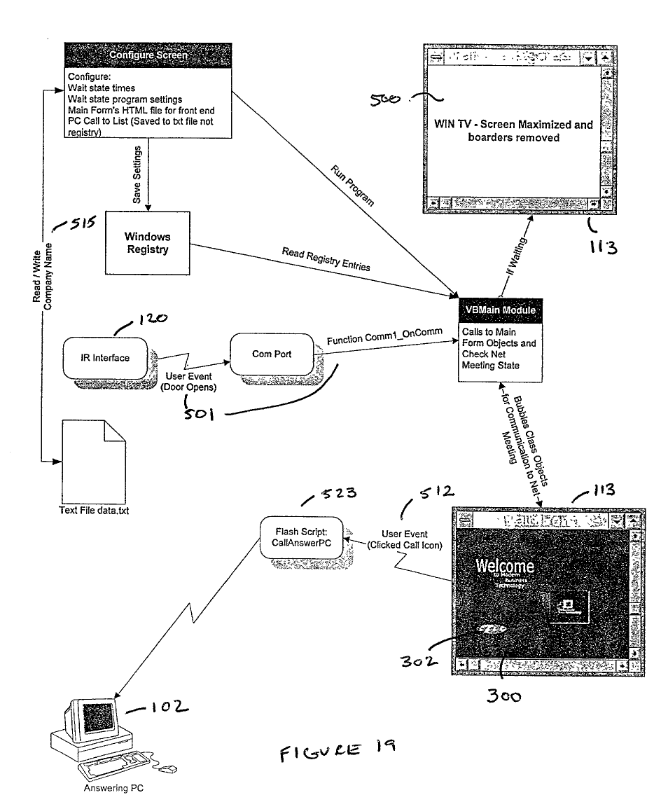

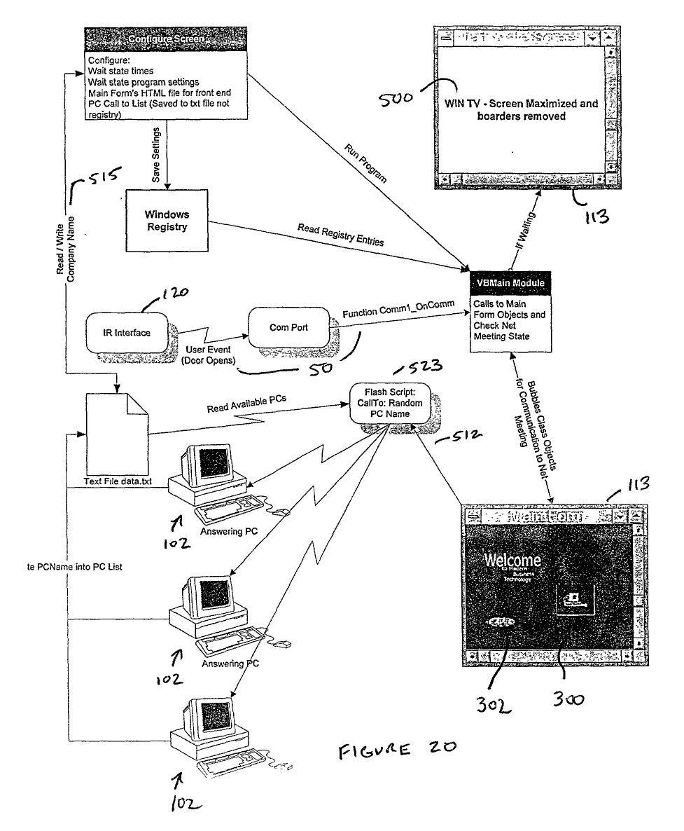

Operation of the visitor greeting system according to the first embodiment of the present invention will now be described in detail. A flow chart showing the detailed operation is shown in FIG. 12 (see also FIGS. 19-20). Prior to a visitor entering the lobby or reception area of the business, the visitor greeting system is in a wait state (see 500). In this state, the visitor greeting system can be configured to do any of a number of things. In one embodiment, the visitor greeting system is configured to display television programing on the lobby video output device (an optional television player card is connected to the lobby computer in this embodiment). In another embodiment, a screen saver is displayed on the lobby video output device. In other embodiments, advertising is displayed or other computer application programs are run.

When a visitor enters the lobby or reception area of the business, the visitor's presence is detected by the visitor sensing device and the sensing device sends a signal to the lobby computer indicating the presence of the visitor (see 501). The visitor sensing device is connected to one of the communication ports on the lobby computer. In this embodiment, the visitor sensing device is connected to Com Port 1.

The main form object of the receptionist program running on the lobby computer continuously monitors this port looking for a signal from the visitor sensing device. When a sensor signal is first received, the main form object checks to see if a video conferencing session is in progress or if an attempt (e.g. a request) is being made to set-up a video conferencing session (see 502). If either of these are in process, the visitor greeting system allows the ongoing process to continue and nothing further is done with respect to the newly arrived visitor (see 503).

If no video conferencing session is in progress or being attempted, the main form object sounds an audible signal (ding or bell sound) in the lobby via the lobby audio output device (see 504). The audible sound is played by active multimedia player 342 embedded in the main form 340.

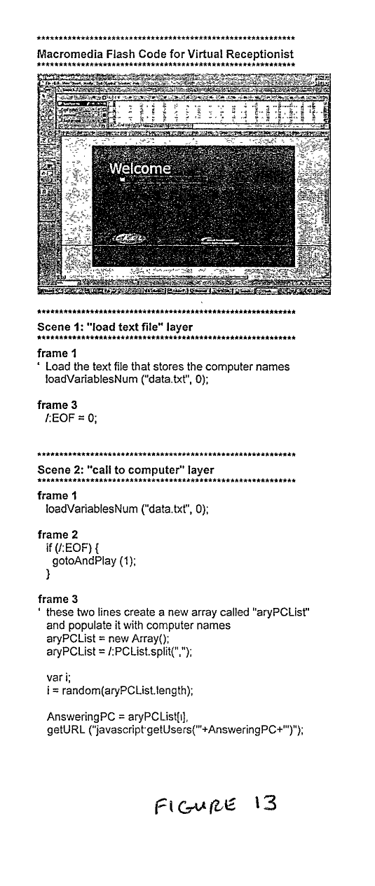

When the visitor greeting system leaves the wait state, it also changes the display on the lobby video output device from the wait state display (e.g. television programming) to a welcome display (see 505). The welcome image in this embodiment is the static welcome display 300 shown in FIG. 5. This display is actually an html web page that is being displayed by the active x web browser object embedded in the main form object. Embedded in the html web page is the second active x multimedia player object and the active x video conferencing object. In this particular embodiment, the embedded multimedia player object is Macromedia Flash® which runs a Flash animation. It is the first scene of the Flash animation (see FIG. 13 for Flash source code) that is actually viewed on the lobby video output device as static welcoming image 300.

After a short time delay following the audible signal (e.g. 5 seconds in this embodiment) (see 506), active multimedia player object 342 plays an audio greeting welcoming the visitor to the business. The main form first determines the time of day (see 507). If the time of day is before 12 noon, a morning audio greeting is played for the visitor (see 508). If the time of day is 12 noon or later, an afternoon audio greeting is played instead (see 509).

Regardless of which greeting is played, the audio greeting welcomes the visitor to the business and instructs the visitor regarding how to proceed. In this particular embodiment, the visitor is instructed to approach the lobby video conferencing station and activate the visitor input device to request a video conferencing session with a receptionist (see 510). The first scene of the Flash animation includes a “Call” button object. It is this button object that the visitor is instructed to activate using the visitor input device (e.g. click-on if a mouse is being used or press if a touch screen is being used)(see 510).

At the same time that the audio greeting is started, a timer is also started (see 511). In this embodiment, the timer is set to 2 minutes but can be set to other durations in other embodiments or may not be used at all). If the visitor has not activated the visitor input device before the time period ends (referred to as the waiting for a response period) (see 512), the receptionist system checks to see if the visitor input device was moved during the waiting for a response period (see 513). If the visitor input device was not moved during the waiting for a response period, the visitor greeting system returns to the wait state.

However, if the visitor input device was moved but not activated (e.g. for example, the mouse pointer in one embodiment was moved on the screen of the lobby video output device but the “Call” button was not clicked) during this period, the waiting for a response period is automatically extended by a short amount of time (e.g. 5 seconds in this embodiment) to allow the visitor to activate the visitor input device. If the visitor input device is moved during the extended waiting for a response period, the waiting for a response period is again extended.

This extension process continues until either no movement of the visitor device is detected during the waiting for a response period or until the visitor input device is activated. If at some point no movement of the visitor input device is detected during either the original or extended waiting for a response period, the visitor greeting system assumes that the visitor has left the building and the visitor greeting system returns to its waiting state.

If the visitor activates the visitor input device by clicking on the “Call” button at any time during the original or any extended waiting for a response period, two things occur. First, the process of establishing a video conference session is begun. Second, the second scene of the Flash animation begins playing which provides an audio/visual greeting to the visitor and instructs the visitor regarding the status of the video conferencing session (see 514).

Once the “Call” button on static welcome image 300 is clicked by the visitor, the Flash animation program begins the process for establishing a video conferencing session between the lobby video conferencing station and a receptionist video conferencing station. The process begins with the Flash program retrieving the NetMeeting e-mail addresses of all of the receptionist computers that are logged into the visitor greeting system from the text data file. This file is stored on the hard drive of the lobby computer in a share directory that is accessible by all of the receptionist computers. The retrieval process begins while frame 1 of scene 2 of the Flash animation is running (see 515). If data is not completely retrieved by the end of frame 2 of scene 2 (see 516) of the Flash animation, the Flash animation returns to Frame 1 of scene 2 (see 517). The Flash animation continues to cycle back and forth between frame 1 and frame 2 of scene 2 until the NetMeeting e-mail addresses of all of the logged in receptionist computers are retrieved by the Flash animation program. Frame 3 of the Flash animation is now shown on the lobby video output device (see 518).

At this point, the NetMeeting addresses of all of the logged in receptionist computers are loaded into an array (see 519) by the Flash program. The Flash program then selects a random number between 1 and the total number of receptionist computers that are logged in to the visitor greeting system. The receptionist computer located at the location of the random number in the array is then selected as the receptionist computer to which the video conferencing call will be made (see 520).

At this point, the Flash program makes a java script call out to the html web page and the NetMeeting e-mail address of the receptionist computer to be called is passed to the html web page (see 521). The html web page then passes the NetMeeting e-mail address of the receptionist computer to the active video conferencing object embedded in the html web page (see 522) and the video conferencing object requests a video conferencing session with the selected receptionist computer (see 523) using a lightweight directory access protocol (LDAP).

At approximately the same time, the html web page clicks the B3 button embedded into itself (see 524). The bubble class object bridging the html page with the main form object monitors the html page during this entire time. When it detects that button B3 has been clicked, the bubble class notifies the main form object (see 525). The main form object then sets a 30 second timer in this embodiment and further allows the lobby computer to continue working on whatever it was working on at the time (see 526).

The 30 second timer is provided because the NetMeeting® video conferencing object will make the request for the video conferencing session for only 30 seconds in this embodiment. After attempting to make the call for 30 seconds with no success, the video conferencing object will display a message on the lobby video output device indicating that the designated receptionist computer is not answering (see 527, 528). The lobby video conferencing station will then return to the wait state.

If the receptionist computer answers the request for a video conferencing session within the 30 second period, a video conferencing session is then initiated by the receptionist video conferencing station (see 529). At this point, the active video conferencing object instructs the html page to click button B1 embedded on the html web page (see 530). As before, the bubble class monitoring the html page communicates to the main form object that button B1 has been clicked on the html page (see 531) and the main form object checks to see if either the morning or afternoon audio greeting are playing (see 532). If it is, it is immediately stopped to allow for the video conferencing session to proceed (see 533).

At this point, the receptionist engages in real time audio and visual communication with the visitor. The receptionist welcomes the visitor to the business and ascertains the purpose for the visit (see 534).

When the receptionist is done helping the visitor, the video conferencing session is ended by the receptionist computer (see 535). The video conferencing object then instructs the html page to click button B2 embedded in the html web page (see 536). Once again, the bubble class bridging between the html page and the main form object notifies the main form object that button B2 has been clicked (see 537). The main form object then resets itself so that it knows that no video conferencing session is in progress or being attempted (see 538). As a result, the main form object returns to its wait state and waits for the next visitor to enter the building at which point the entire process begins anew.

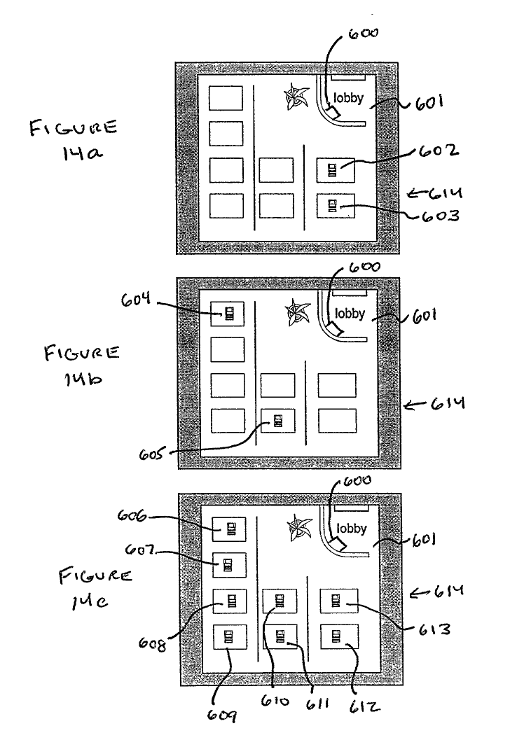

FIGS. 14a-c show one embodiment of the present invention as used in a single lobby single building application. In FIGS. 14a-c, a single lobby video conferencing station 600 is located in the lobby 601 of the building 614. In FIG. 14a, two receptionist video conferencing stations 602, 603 are remotely located from lobby 601 of the building but are located in the same general area of the building. In FIG. 14b, two receptionist video conferencing stations 604, 605 are remotely located from lobby 601 of the building and are scattered throughout the building. In each of these embodiments, one of the receptionist video conferencing stations can be the primary receptionist video conferencing station and the other can be a back-up. In FIG. 14c, eight receptionist video conferencing stations 606-613 are provided to answer a request for a video conferencing session from lobby video conferencing station 600.

The embodiments of the present invention described thus far have all been limited to a single lobby video conferencing station. The present invention, however, is not limited to single lobby applications. In alternative embodiments of the present invention, multiple lobby video conferencing stations are provided. A building having multiple entrances, for example, can have a lobby video conferencing station located at each of the entrances. Similarly, a building having multiple floors can have a lobby video conferencing station in the reception area on each floor. Each of the plurality of lobby video conferencing stations in these embodiments is connected to one or more remotely located receptionist video conferencing stations. The connection between the lobby video conferencing stations and the remotely located receptionist video conferencing station or stations in these embodiments will typically be via a local area network such as an ethernet or token ring network, however other types of connections can be used.

The remotely located video conferencing stations are all located in the building having the plurality of lobbies in one embodiment. In another embodiment, one or more of the receptionist video conferencing stations are located in a building different from the building having the plurality of lobbies.

In yet another alternative embodiment of the present invention, multiple lobby video conferencing stations are provided. A lobby video conferencing station is positioned at each of the multiple entrances to the building and/or is located on each of the multiple floors of the building that have their own receptions area. Each of the lobby video conferencing stations is connected to a remotely located receptionist video conferencing station that is located in the main visitor reception area or lobby of the building.

In this embodiment, the dedicated receptionist located at the main visitor lobby can welcome visitors to the other building reception areas and entrances via the receptionist video conferencing station located in the main lobby. In this way, only a single dedicated receptionist is needed to monitor all of the building's lobbies and reception areas. One or more additional receptionist video conferencing stations can also be located remote from the main visitor lobby in this embodiment. These additional remote receptionist video conferencing stations can act as back-ups in case the dedicated receptionist at the main visitor lobby is unavailable (e.g helping other visitors). In another embodiment, the receptionist video conferencing station located in the main visitor lobby is also a lobby video conferencing station. In this way, the main entrance can be monitored by the additional back-up remotely located receptionist video conferencing stations when the dedicated receptionist is out sick, at lunch or on break.

In other embodiments of the present invention, lobby video conferencing stations are placed in the lobby of each of a plurality of buildings that are located at a single campus location. Each of the lobby video conferencing stations is connected to one or more remotely located receptionist video conferencing stations.

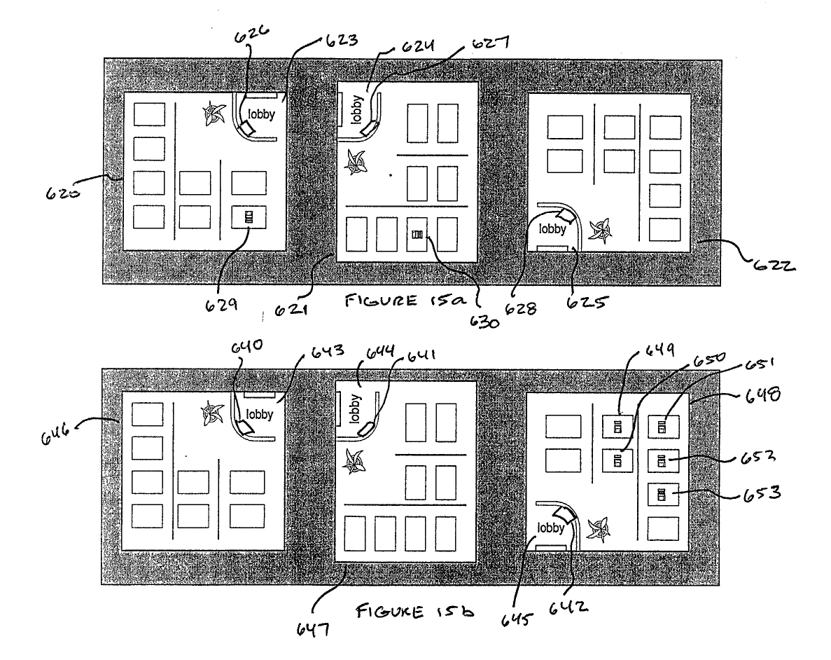

FIG. 15a shows an embodiment of the present invention being used in such an application. In FIG. 15a, three buildings 620, 621, 622 are located on the business campus. Each building has its own lobby 623, 624, 625. Lobby video conferencing stations 626, 627 ,628 are placed in each of the lobbies. In this embodiment, two remotely located video conferencing stations 629 and 630 are provided to cover the three lobbies. One of the remotely located receptionist video conferencing stations acts as the primary station while the second is a back-up station. In an alternative embodiment, both remotely located receptionist video conferencing stations are primary and one of them is randomly selected to welcome a visitor.

In this embodiment, one of the remote receptionist video conferencing stations is located in building 620 while the second receptionist video conferencing station is located in building 621. No receptionist video conferencing station is located in building 622. In this embodiment, a visitor entering any of the three building lobbies can be welcomed by either of the two remotely located receptionist video conferencing stations 629, 630.

In an alternative campus embodiment shown in FIG. 15b, lobby video conferencing stations 640, 641, 642 are placed one each in the three campus building lobbies 643, 644, 645 of buildings 646, 647, 648. Five receptionist video conferencing stations 649-653 are used to monitor each of the three lobbies in this embodiment. In this particular embodiment, all of the remote receptionist video conferencing stations are located in building 648 although as previously mentioned this is not a requirement and they could be scattered among the three buildings depending on the circumstances.

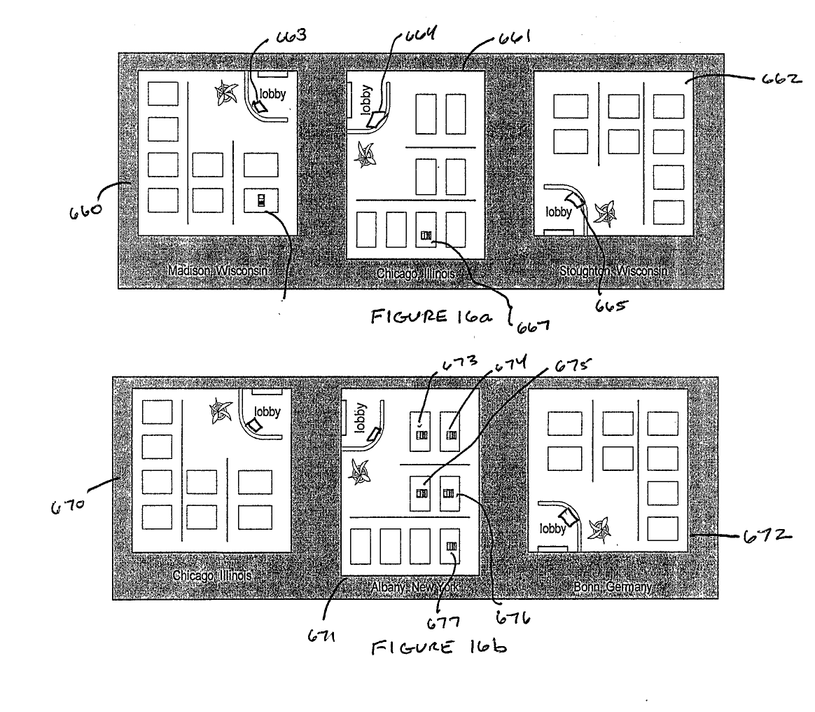

FIG. 16a shows another embodiment of the present invention wherein the buildings are located in various cities throughout the country. For example, building 660 is located in Madison, Wis., building 661 is located in Chicago, Ill. and building 662 is located in Stoughton, Wis. in this embodiment. Each of these buildings includes a lobby video conferencing station 663, 664, 665 near its entrance.

Two receptionist video conferencing stations 666, 667 are provided in this embodiment. One is located in the back-end of building 660 while the other is located in the back-end of building 661. Again, each of the remotely located receptionist video conferencing stations is connected to each of the lobby video conferencing stations and is configured to engage in a video conferencing session with the lobby video conferencing stations.

Receptionist video conferencing station 666 located in building 660, for example, is connected to lobby video conferencing station 663 via a local area network and is connected to lobby video conferencing stations 664, 665 via a wide area network or via the Internet in this embodiment. Similarly, receptionist video conferencing station 667 located in building 661 is connected to lobby video conferencing station 664 via a local area network and is connected to lobby video conferencing stations 663, 665 via a wide area network or via the Internet. Because there is no receptionist station locally located in building 662, lobby video conferencing station 665 will typically be connected to receptionist video conferencing stations 666, 667 via a wide area network or the Internet.

In this embodiment, selection of the receptionist video conferencing station can be on a primary/backup basis, on a random selection basis, on a hunting basis, on a first to respond basis or can be based on location. A selection based on location as used herein means that the locally located receptionist video conferencing station is first called and the non-locally located receptionist video conferencing stations provide back-up assistance.

FIG. 16b shows another embodiment of the present invention. This embodiment is similar to the embodiment shown in FIG. 16a having three buildings 670, 671, 672 located throughout the world (e.g. one in Chicago, Ill., one in Albany, N.Y. and one in Bonn, Germany). In this embodiment, unlike the embodiment of FIG. 16a, all of the receptionist video conferencing stations 673-677 are located in one of the three buildings, namely the building in Albany, N.Y.

In another embodiment of the present invention, a visitor greeting answering service is established to welcome visitors. The visitor greeting answering service can either be operated by a third party contracting with the various businesses to provide the visitor greeting service or it can be set-up by a business itself to handle the greeting of visitors to some or all of its various locations.

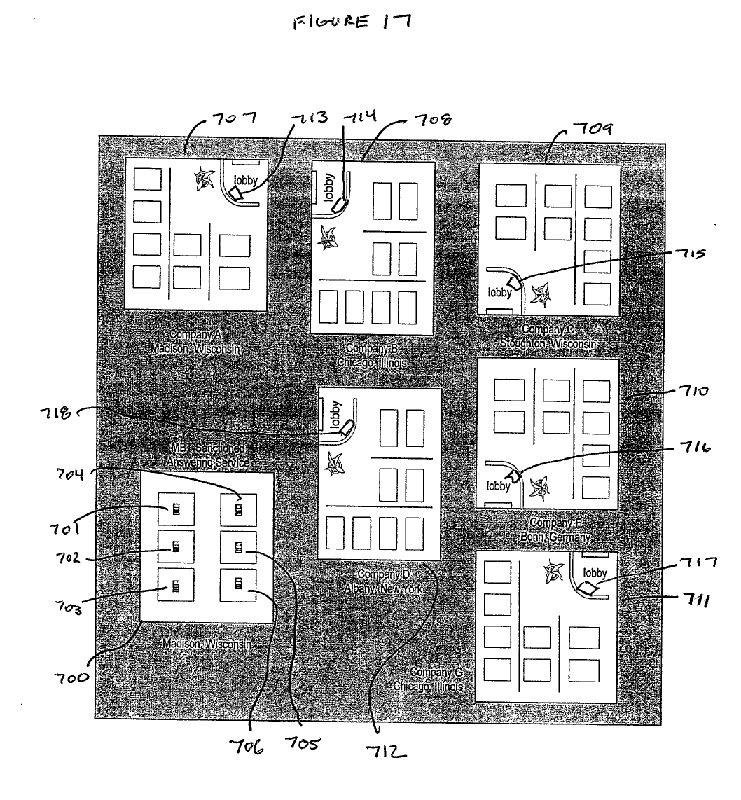

In one embodiment, shown in FIG. 17, a video conferencing call center 700 is established. In alternative embodiments, a plurality of video conferencing call centers are provided. The video conferencing call center typically will include one or more receptionist video conferencing stations. In this embodiment, video conferencing call center 700 includes six receptionist video conferencing stations 701-706. Each of the businesses 707-712 that subscribe to the visitor greeting answering service will have a lobby video conferencing station 713-718 installed in the lobby of its building. Each of the lobby video conferencing stations is connected to the plurality of receptionist video conferencing stations in this embodiment. In this way, a third party answering service can welcome visitors to a multitude of businesses using any of the video conferencing systems and methods described herein.

Numerous modifications may be made to the present invention which still fall within the intended scope hereof. Thus, it should be apparent that there has been provided in accordance with the present invention a system and method for greeting a visitor to a business that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A system for welcoming a visitor to a business comprising:
a lobby video conferencing station; and
a plurality of receptionist video conferencing stations each of which is remotely located from the lobby video conferencing station wherein a receptionist positioned at a randomly selected one of the plurality of receptionist video conferencing stations initiates a video conferencing session with the visitor via the lobby video conferencing station to welcome the visitor to the establishment.
